(19) United States
(12) Patent Application Publication
(10) Pub. No.: US 2007/0079245 A1
(43) Pub. Date: Apr. 5, 2007

(54) Method and apparatus for providing application with remote-controllable interface

(75) Inventor: Jung-hwan Oh, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/417,198

(22) Filed: May 4, 2006

(30) Foreign Application Priority Data
May 4, 2005 (KR) 2005-37666

(51) Int. Cl. G09G 5/00

(52) U.S. Cl. 715/740; 345/156

(57) ABSTRACT

A method of and an apparatus for providing an application with a remotely controllable interface. An application is displayed in a first mode, in which the user interface is controllable using a mouse or a keyboard. Predetermined data specifying an appearance of the application is collected, the predetermined data are modified to display the application in a second mode, in which the user interface is controllable with a remote control, and the modified data are stored.

### CROSS-REFERENCE TO RELATED APPLICATIONS

This application claims the benefit of Korean Application No. 2005-37666, filed May 4, 2005, in the Korean Intellectual Property Office, the disclosure of which is incorporated herein by reference.

### BACKGROUND OF THE INVENTION

1. Field of the Invention

Aspects of the present invention relate to a method of and an apparatus for providing an application with a remotely-controllable interface, and more particularly, to a method of and an apparatus for providing an application comprising an interface controllable from a short distance with an interface that is remotely controllable.

2. Description of the Related Art

With recent developments in home network technologies, an increasing number of computers, digital TVs, VCRs, and set-top boxes that integrate with one another and thus perform functions other than their own functions have been developed. As part of this trend, an increasing number of remotely-controllable interfaces that perform functions in response to a signal received from a remote control have been developed and have replaced existing computer interfaces that are usually controlled by a mouse or a keyboard.

As a size of computer monitors increases and an increasing number of digital TVs useable as computer monitors are developed, more users feel inconvenienced using conventional data input/output methods that generally involve the use of a keyboard or a mouse. Such conventional data input/output methods require users to sometimes input a large amount of data and impose distance restrictions on users because they are based on wired communication. Even though wireless mice and wireless keyboards have recently been developed, data input/output methods using a wireless mouse or a wireless keyboard are not much different from data input/output methods using a wired mouse or a wired keyboard in that the wireless mouse and the wireless keyboard methods are text-based/icon-based data input/output methods.

The Microsoft Media Center has developed a 10-foot user interface that can overcome restrictions imposed on existing computer interfaces and can integrate with various home appliances. The 10-foot user interface provides an interface for operating a computer from a distance of about 10 feet (i.e., about 3 m) from a display device such as a computer monitor or a digital TV. Existing computer interfaces that are controlled using a keyboard or a mouse generally operate a computer from a close distance of about 2 feet (i.e., about 60 cm) from a display device and are thus referred to as 2-foot interfaces. When an application adopts a 10-foot user interface, a user may easily use the application using a remote control. Existing computer monitors provide remote control-based interface functions that are usually embedded in digital TVs or DVD players and are executed using directional buttons or other buttons on a remote control, and thus, a user does not need to be in the vicinity of a computer monitor to enjoy such interface functions.

Computer companies have made great efforts to establish home networks in which various home appliances integrate with one another via 10-foot user interfaces. However, it is costly and time-consuming to replace existing 2-foot user interface-based applications with 10-foot user interface-based applications.

Reproduction of multimedia content such as playback of a DVD or reproduction of music files, moving images or still images may be carried out using only a limited number of functions such as a stop function, a playback function, and a volume control function. However, if an application that provides such multimedia content reproduction services does not support a 10-foot user interface, a user must control the application with the aid of a mouse or a keyboard in the close vicinity of, for example, a computer system where the application is executed in order to play back multimedia content or stop the playback of the multimedia content, which may be inconvenient to the user.

Recently, an increasing number of computer applications that provide a 10-foot user interface have been developed. However, in order to make existing applications remotely-controllable, it is necessary to develop ways to easily convert a 2-foot user interface into a 10-foot user interface without changing the entire application.

### SUMMARY OF THE INVENTION

An aspect of the present invention provides a method of and an apparatus for providing an existing application with a 10-foot user interface.

An aspect of present invention provides a method of and an apparatus for providing an existing application with a 10-foot user interface to enable the existing application to integrate with various digital home appliances.

According to an aspect of the present invention, there is provided a method of displaying an application in a first mode, in which the user interface is controllable using a mouse or a keyboard, collecting predetermined data defining an appearance of the application, modifying the predetermined data such that the application is displayable in a second mode, in which a user interface is controllable with a remote control, and storing the modified data.

According to another aspect of the present invention, there is provided a method of displaying an application including receiving predetermined data defining the appearance of the application in a predetermined mode, in which a user interface is controllable with a remote control, displaying the application in the predetermined mode, and receiving an input signal choosing one of a plurality of elements of the application from the remote control.

According to another aspect of the present invention, there is provided a computer system including an application analysis unit executing an application in a first mode, in which a user interface is controllable using a mouse or a keyboard, and collecting predetermined data specifying an appearance of the application, and an application conversion unit modifying the predetermined data such that the application is displayable in a second mode, in which the user interface is controllable with a remote control.

According to another aspect of the present invention, there is provided a computer system including a signal reception unit receiving an input signal transmitted by a remote control, a data reception unit receiving predetermined data specifying the appearance of an application so that the application is executable in a predetermined mode, in which the user interface is controllable with a remote control, and a display control unit displaying the application in the predetermined mode, wherein the display control unit performs a predetermined function of the application in response to the input signal while displaying the application in the predetermined mode.

According to another aspect of the present invention, there is provided a software program including an event processing unit converting an input signal transmitted by a remote control into an event signal for a predetermined element of an application, and a control unit executing a function provided by the predetermined element when the element receives the event signal, wherein the application is executed in a predetermined mode comprising an interface that is remotely controllable, and in the predetermined mode, the application is displayed such that the application is controllable from a distance of one meter or greater.

According to another aspect of the present invention, there is provided a storage medium including predetermined data specifying an appearance of an application so that the application is executable in a predetermined mode, in which the user interface is controllable with a remote control, and an interface processing unit converting the application based on the predetermined data when the application is executed, wherein the predetermined data comprises information specifying functions provided by each of a plurality of elements of the application when a corresponding element is executed.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating various objects of a media player;

FIG. 2 is a diagram illustrating resource information of the media player objects of FIG. 1;

FIG. 3 is a diagram illustrating a method of converting a 2-foot user interface into a 10-foot user interface according to an embodiment of the present invention;

FIG. 4 is a diagram illustrating a screen displayed by an application that is executable via a 10-foot user interface;

FIG. 5 is a diagram illustrating a relationship between a 2-foot user interface and a 10-foot user interface according to an embodiment of the present invention;

FIG. 6 is a flowchart illustrating a method of converting a user interface of an application into a 10-foot user interface according to an embodiment of the present invention;

FIG. 7 is a flowchart illustrating a method of converting a signal input via a 10-foot user interface into a message compatible with a function corresponding to the input signal and executing the function according to an embodiment of the present invention;

FIG. 8 is a block diagram of an interface conversion unit according to an embodiment of the present invention; and

FIG. 9 is a block diagram of an interface processing unit according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Embodiments of the present invention are described below with reference to flowchart illustrations of methods of and apparatuses for providing an application with a remotely-controllable interface. It will be understood that each block of the flowchart illustrations, and combinations of blocks in the flowchart illustrations, may be implemented by computer program instructions. The implementing computer program instructions may be provided to a processor of a general purpose computer, special purpose computer, or other programmable data processing apparatus to produce a machine, such that the instructions, which execute via the processor of the computer or other programmable data processing apparatus, implement the functions specified in the flowchart block or blocks.

The implementing computer program instructions may also be stored in a computer usable or computer-readable memory that directs a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operations to be performed on the computer or other programmable apparatus to produce a computer implemented process such that the instructions that execute on the computer or other programmable apparatus provide operations for implementing the functions specified in the flowchart block or blocks.

Each block of the flowchart illustrations may represent a module, segment, or portion of code, which comprises one or more executable instructions implementing the specified logical function(s). It should also be noted that in some alternative implementations, the functions noted in the blocks may occur in a different order than the order specifically illustrated. For example, two blocks shown in succession may be executed substantially concurrently or the blocks may be executed in the reverse order, depending upon the functionality involved.

For a better understanding of embodiments of the present invention, it will be described in terms of how the embodiments are applied to an interface based on the Microsoft Windows operating system. However, the embodiments of the present invention may be applied to an operating system other than the Microsoft Windows operating system. In other words, the embodiments of the present invention may be applied not only to interfaces based on the Windows operating system but also to interfaces based on an operating system other than the Windows operating system as long as the interface receives signals via a keyboard or a mouse and perform functions in response to the received signals. For example, the embodiments of the present invention may be applied to Unix or Linux interfaces such as X-Windows and to Macintosh interfaces.

Before explaining the embodiments of the present invention, terms used in the specification will now be described briefly. However, it is noted that the use of any and all examples, or exemplary terms provided herein is intended merely to better illuminate the invention and is not a limitation on the scope of the invention unless otherwise claimed.

“Events” are signals input via a keyboard or a mouse, such as keystrokes or mouse clicks or drags. In this disclosure, messages transmitted to an application will now be referred to as events. However, such messages may be referred to in terms other than the term “events.” In other words, such messages may be referred to as, for example, messages, events, or interrupts, according to the type of operating system or the method used to implement an interface.

In this specification, an existing interface will be termed as a 2-foot user interface and a remotely-controllable interface will be termed as a 10-foot user interface by way of example. The 2-foot user interface is an interface that is controllable using a keyboard or a mouse from a short distance, and the 10-foot user interface is an example of an interface that is controllable from a long distance using directional buttons of a remote control.

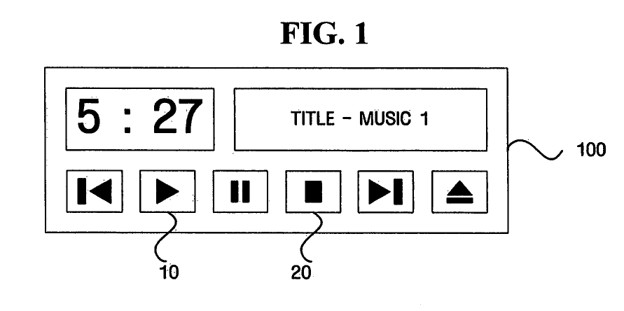

An application using a window based interface, such as for example, Windows or X-Windows comprises a large number of objects. FIG. 1 is a diagram illustrating various objects of a media player.

In FIG. 1 a media player 100 comprises a plurality of buttons, including a play button 10, a stop button 20, and a window frame (not numbered). The buttons and the frame are objects and are designed to perform particular functions when corresponding respective events are generated. For example, when the play button 10 is pressed using a mouse, information indicating that a mouse click event has been generated is transmitted to the play button 10. Then, an event handler determines which of a plurality of functions registered with the play button 10 is to be performed in response to the mouse click event. Information specifying the relationship between events and functions is registered with the event handler. Therefore, information specifying a relationship between a button and function to be executed in response to a mouse click event is pre-defined in the media player 100.

The media player 100 also includes information regarding how to display each of the objects contained therein as well as information specifying what functions are performed by each of the objects. For example, the media player 100 may store information indicating that the displayed stop button 20 is to be 120 pixels long and 100 pixels wide as detailed object information. Therefore, if information regarding the object is changed, the method in which the objects are displayed is changed accordingly. Information detailing an object is referred to as resource information. Resource information is information that is needed for displaying an application or implementing an interface of the application. Resource information may exist independently of an application.

Most Windows interfaces realize a number of objects as windows. Buttons, captions, radio buttons, and checkboxes of a window in which an application is driven are considered to be windows. Therefore, an application is considered to be a set of 2 or more windows. The window in which an application is driven and within which a plurality of windows of the application are systematically displayed is referred to as an uppermost window.

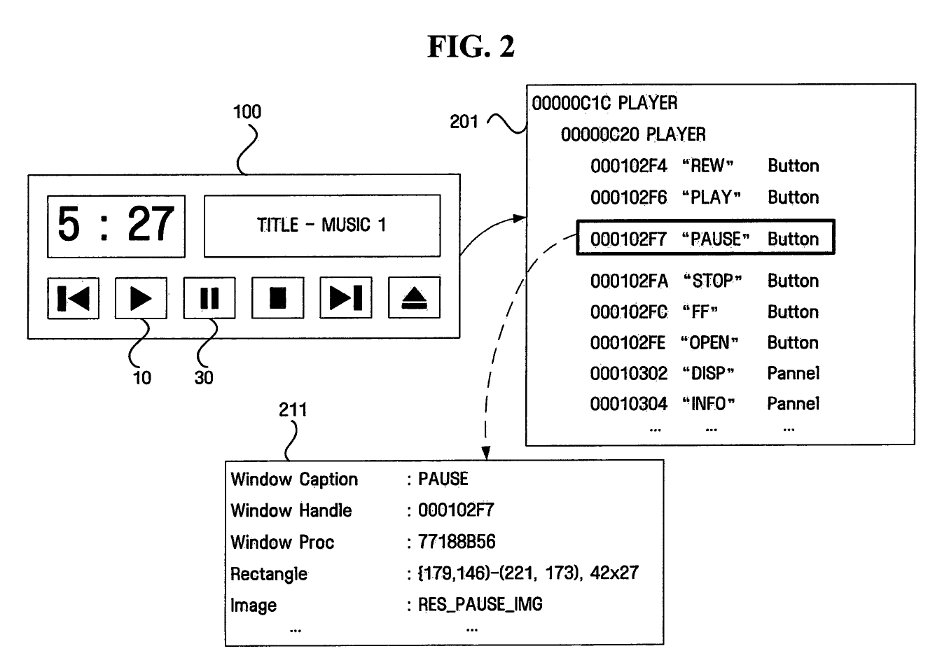

FIG. 2 is a diagram illustrating resource information of the media player 100 of FIG. 1. FIG. 2 illustrates resource information 201 and detailed resource information 211 displayed when executing a program such as Spy++ which displays information regarding a plurality of windows of an application (i.e., the media player 100 of FIG. 1) and information regarding a plurality of events.

Information regarding the windows of the media player 100 is displayed as resource information 201. The resource information 201 comprises a plurality of window handle values, a plurality of window captions, and a plurality of pieces of window type information of the respective windows of the media player 100. The resource information 201 describes that the media player 100 has a window caption “PLAYER” and has a unique identifier, i.e., a window handle “00000C1C”. The resource information 201 lists a window having the window caption “PLAYER” and a window handle value of 00000C20 as an uppermost window comprising all the objects of the media player 100. The uppermost window comprises a plurality of windows, which are panels that provide information regarding a plurality of buttons of the media player 100 and information regarding the media player 100. Each of the panels provides a window handle, a window caption, and window type information of a corresponding window. A window handle may be regarded as an identifier of a corresponding panel, a window caption may be regarded as the name of the corresponding panel, and window type information labels the corresponding panel as “Button” or “Panel”. Detailed resource information 211 is detailed information regarding a pause button 30 of the medial player 100. The detailed resource information 211 will now be described in further detail.

The pause button 30 has a window caption “PAUSE”. Therefore, if a window corresponding to the pause button 30 is not associated with an image, the window caption “PAUSE” is displayed in the window corresponding to the pause button 30. However, since the pause button 30 is associated with an image as illustrated in FIG. 2, the window caption “PAUSE” is not displayed in the window corresponding to the pause button 30.

The pause button 30 has a window handle value of 000102F7 to uniquely identify the pause button 30 among other buttons of the window interface. ‘Window Proc’ is a serial number of a predetermined process handling the window corresponding to the pause button 30. ‘Rectangle’ is information regarding an area occupied by the window corresponding to the pause button 30. ‘Image’ is information regarding a predetermined image displayed within the window corresponding to the pause button 30, and ‘RES_PAUSE_IMG’ indicates a resource providing the predetermined image.

Information regarding a size and location of a window and information regarding an image displayed within the window are provided as resource information. Resource information is regarded as a set of data needed to implement an application or a window. Therefore, a 2-foot user interface may be converted into a 10-foot user interface by appropriately altering resource information of the 2-foot user interface.

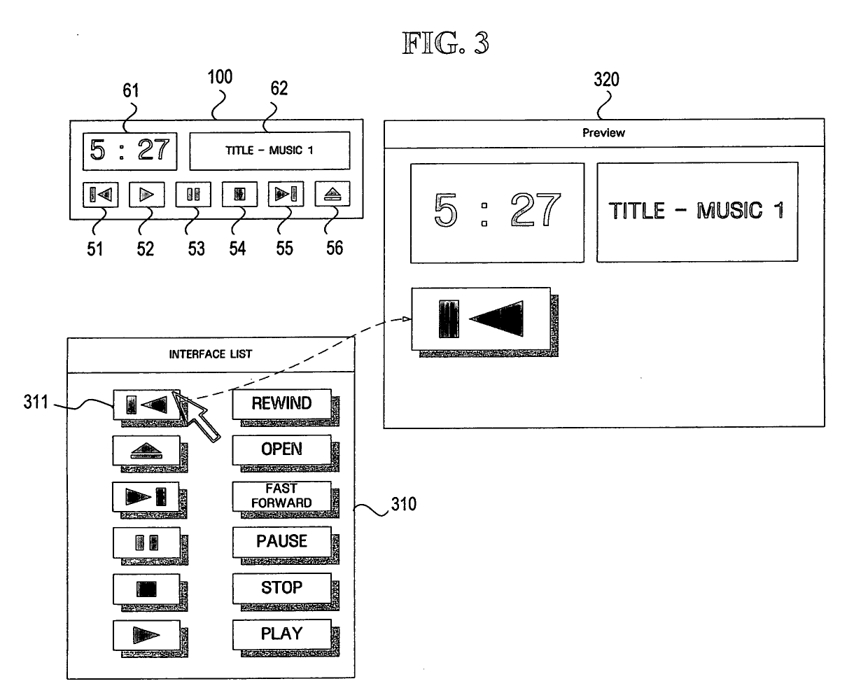

FIG. 3 is a diagram illustrating a method of converting a 2-foot user interface into a 10-foot user interface according to an embodiment of the present invention. An application converting the 2-foot user interface into the 10-foot user interface is executed, and for each of a plurality of buttons of a media player 100, a 10-foot user interface element that will replace a 2-foot user interface element is chosen. For example, a rewind button 51 of the media player 100 is pressed, and one of a plurality of 10-foot user interface elements listed in an interface list 310, e.g., a 10-foot user interface element 311, is chosen for the rewind button 51. Thereafter, the chosen 10-foot user interface element 311 is clicked or dragged such that the interface element 311 is displayed in a preview window 320. The preview window 320 shows how a 10-foot user interface that the user sets will be displayed by a display device such as a computer monitor, a laptop computer monitor or a digital TV.

A location where the chosen 10-foot user interface element 311 is to be displayed may be determined automatically or manually. The interface list 310 may also comprise a plurality of images. The images included in the interface list 310 may be chosen from among a plurality of templates stored in advance. Therefore, the user does not choose templates that the user deems unnecessary as 10-foot user interface elements. In this manner, the user converts a 2-foot user interface into a 10-foot user interface. Alternatively, a plurality of templates stored in advance may be automatically displayed to a user so that the user may determine whether to choose each of the templates as a 10-foot user interface element.

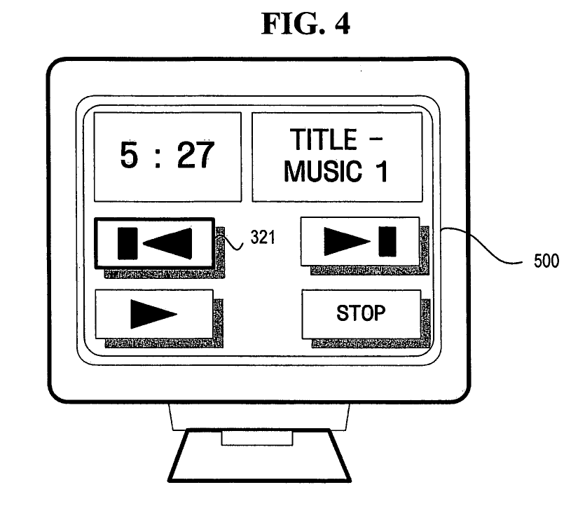

FIG. 4 is a diagram illustrating a screen displayed by an application that is executed via a 10-foot user interface. Interface elements such as buttons or panels set by the user using the preview window 320 are displayed on a screen, and the user may choose any of the interface elements using a remote control.

In detail, the user may move a cursor from one button item to another using directional keys of the remote control. Thereafter, if the user presses an execute button or an enter button of the remote control, a signal corresponding to a button currently being highlighted by the cursor (the current button) is received and is converted into a click event signal. Therefore, an effect of pressing the current button may be obtained by highlighting the current button and pressing the execute button or the enter button using the remote control to generate a click event for a corresponding application.

For example, the user may choose a button 321 using the directional keys of the remote control. Then, the button 321 may be highlighted by changing a color of the button 321, displaying the button in a bold outline, or dynamically animating an image displayed within the button 321 so that the user is notified that the button 321 is chosen. Then, if the user presses an execute button or an enter button of the remote control when the button 321 is highlighted, a signal corresponding to the button 321 is converted into a click event. As a result, a function of the button 321, i.e., a rewind function, is performed. A control signal or an input signal generated by the remote control is transmitted to elements of an interface and then to an application. Specifically, information compatible with an operating system on which the application runs is transmitted to the application.

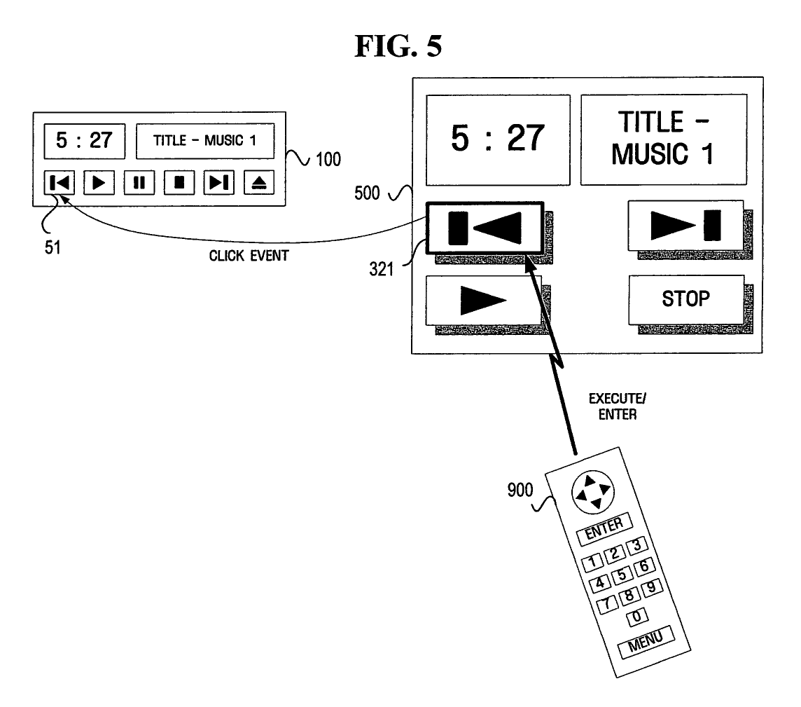

FIG. 5 is a diagram illustrating a relationship between a 2-foot user interface and a 10-foot user interface according to an embodiment of the present invention.

A 10-foot user interface element is set in an existing application 100 by changing resource information regarding the existing application 100, and thus, a 10-foot user interface 500 is displayed on a screen when the existing application 100 is executed. If the resource information regarding the existing application 100 refers to a resource file of the existing application 100, a resource file capable of supporting a 10-foot user interface may be newly generated and used. When the 10-foot user interface 500 is displayed on the screen, a user may choose any of a plurality of buttons in the 10-foot interface 500 using a remote control 900. The user may move a cursor from one button to another using directional keys of the remote control 900. When the user presses an enter button when a cursor is located on a button 321, the 10-foot user interface 500 receives a predetermined signal indicating that the enter button has been pressed by the user. The predetermined signal is converted into a click event corresponding to a rewind button 51 of the existing application 100, and the click event is transmitted to the existing application 100. Then, an event handler calls a function provided by clicking the rewind button 51 in response to the received click event like mouse.

The above described method of converting a 2-foot user interface into a 10-foot user interface may be applied not only to a single application at a time but also to more than one application at a time. In other words, the above described method of converting a 2-foot user interface into a 10-foot user interface may enable a 10-foot user interface to be generated for 2 or more applications.

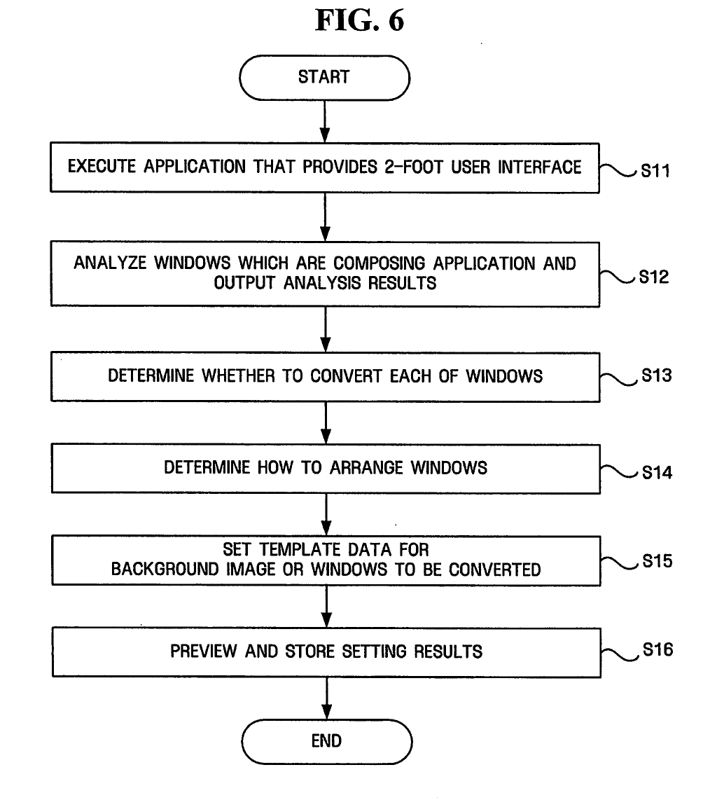

FIG. 6 is a flowchart illustrating a method of converting a user interface of an application into a 10-foot user interface according to an embodiment of the present invention.

A 10-foot user interface is driven. In operation S11, a predetermined application providing a 2-foot user interface is executed. When the predetermined application is executed, resource information of each of a plurality of windows of the predetermined application may be obtained. Thus, in operation S12, the windows are analyzed using an analysis program, and the analysis results are displayed in such a manner that a user may easily understand what the windows are. Resource information, including information specifying the sizes and names of the windows and information regarding images to be displayed within the windows, is provided to the user as illustrated in FIG. 2. In operation S12, there is no need to provide as much detailed resource information as is needed for developing a program to the user. Instead, only resource information needed for freely determining the shapes or locations of the windows is provided to the user.

In operation S13, it is determined which of a plurality of windows, for example, buttons or panels, is to be displayed in a 10-foot user interface based on the provided resource information. In operation S14, after determining which of the plurality of windows is to be displayed, it is determined how to arrange the windows. In operation S15, the shapes of the windows or the templates of a background image on which the windows are to be displayed are read and set. Operations S13 through S15 may be performed in a different order from the order set forth herein. For example, as illustrated in FIG. 3, a window (e.g., a button or a panel) of an application may be clicked, and then an image that is to be displayed in a 10-foot user interface in association with the window may be chosen and dragged. Alternatively, the user may be automatically provided with a preview of how the application will be displayed when converting a user interface of the application into a 10-foot user interface and then allowed to choose whether to convert the user interface of the application into a 10-foot user interface. Most applications provide only a limited number of functions such as playback, stop, and rewind functions. Thus, even when a user interface of an application is converted into a 10-foot user interface, the way the application is displayed may not change considerably. A 10-foot user interface may be provided to an application simply using template data provided in advance. In operation S16, the windows arrangement determined in operation S14 is examined using, for example, a preview function, and all the settings needed for converting the user interface of the predetermined application into a 10-foot user interface are stored, thereby terminating the method. Here, the settings may be stored as a file. When the settings are stored as a file, the settings may be distributed to and thus provide a 10-foot user interface to other applications. In addition, when the settings are stored as a file, the user may access a server with a computer and download the file from the server, or an application development company may distribute the predetermined application to customers together with the file.

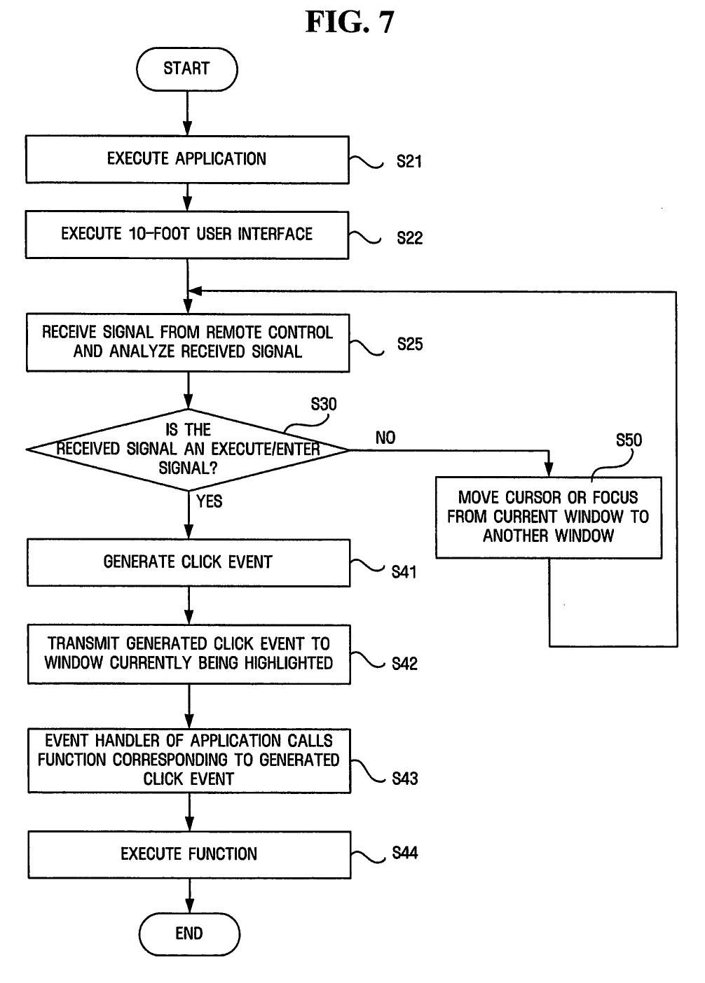

FIG. 7 is a flowchart illustrating a method of converting a signal input via a 10-foot user interface into a message compatible with a function corresponding to the input signal and executing the function according to an embodiment of the present invention. An application may be designed such that a 10-foot user interface is automatically executed for the application when the application is executed. In addition, an event signal may be generated based on a control signal or an input signal generated by a remote control and then transmitted to an application so that a predetermined function of the application is activated or inactivated in response to the event signal.

In operation S21, a predetermined application is executed. In operation S22, a 10-foot user interface corresponding to the predetermined application is executed. When the 10-foot user interface is executed, resource information that has been changed using the method described with reference to FIG. 6 is displayed. Once the 10-foot user interface is executed, the predetermined application may be remotely controlled via a computer monitor or a digital TV connected to a computer. In operation S25, if a user generates a signal by pressing a button on a remote control, the 10-foot user interface receives and then analyzes the signal. In operation S30, it is determined whether the signal is an execute/enter signal for executing a menu or a function. In operation S41, if the signal is determined in operation S30 to be an execute/enter signal, the 10-foot user interface generates a click event. In operation S42, the 10-foot user interface transmits the click event to a window currently being highlighted in the 10-foot user interface (the current window). In operation S43, an event handler calls a function corresponding to the click event. In operation S44, the function is executed. In operation S50, if the signal is determined in operation S30 to be a signal for moving a cursor from the current window to another window, the cursor is moved accordingly. Each of a plurality of windows of the predetermined application may be highlighted by the cursor.

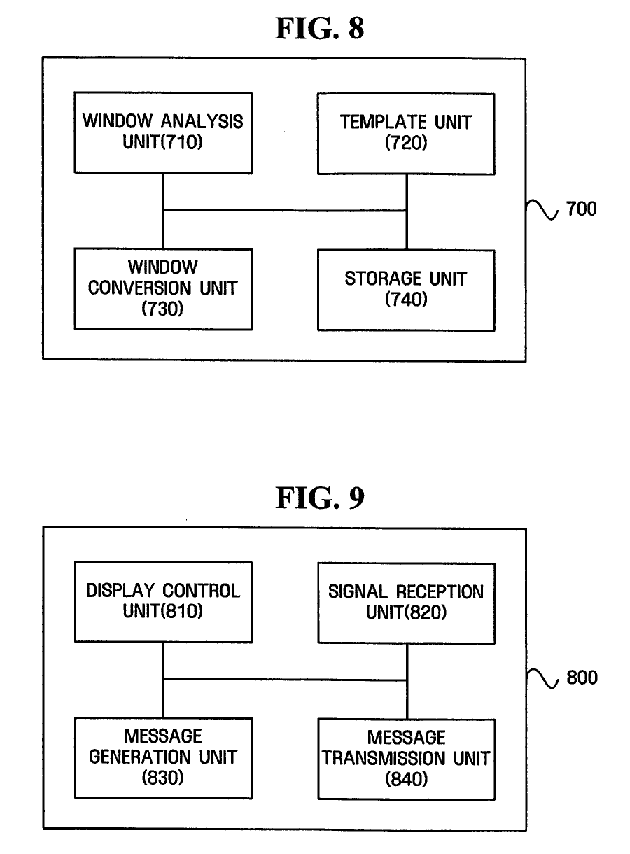

FIG. 8 is a block diagram of an interface conversion unit according to an embodiment of the present invention.

In the embodiments of the present invention described below, a “unit”, “part” or a “module” indicates a software component or a hardware component such as a field-programmable gate array (FPGA) or an application-specific integrated circuit (ASIC). The unit performs a particular function but is not restricted to software and hardware. The unit may be included in an addressable storage medium or may be configured to play one or more processors. Accordingly, units may include components such as software components, object-oriented software components, class components, and task components, processes, functions, attributes, procedures, subroutines, segments of a program code, drivers, firmware, microcodes, circuits, data, databases, data structures, tables, arrays, and parameters. Components and features provided by units may be combined into a smaller number of components and a smaller number of units, or may be divided into a greater number of components and a greater number of units. In addition, components and units may be implemented such that they play one or more central processing units (CPUs) in a device or a secure multi-media card (MMC).

An interface conversion unit 700 analyzes each of a plurality of windows of an application that provides a 2-foot user interface and provides a 10-foot user interface to the application. The interface conversion unit 700 may be realized as a software program or as a system-on-chip (SOC).

A window analysis unit 710 analyzes resource information of each of the windows of the application. The windows include buttons, panels, and checkboxes, and the window analysis unit 710 obtains information regarding the location and size of each of the buttons, panels, and checkboxes. A template unit 720 provides 10-foot user interface template data for button images and colors and background images. A user may optionally modify the 10-foot user interface template data stored in the template unit 720 and use the modified 10-foot user interface template data. A window conversion unit 730 converts the windows of the application into windows compatible with a 10-foot user interface by using the 10-foot user interface template data stored in the template unit 720 or by modifying the 10-foot user interface template data based on the images or colors chosen by the user. A storage unit 740 stores resource information of the windows obtained by the window conversion unit 730 to provide a 10-foot user interface to the application based on the resource information whenever the application is executed.

FIG. 9 is a block diagram of an interface processing unit according to an embodiment of the present invention.

An interface processing unit 800 outputs an interface generated by the interface conversion unit 700, receives a signal input from a remote control by the user, and processes the received signal.

In detail, a display control unit 810 controls the application so that the application is displayed via a 10-foot user interface instead of via the original 2-foot user interface. The display control unit 810 outputs resource information of the 10-foot user interface. A signal reception unit 820 receives a control signal or an input signal from a device such as a remote control which enables the user to input a signal to the application from a long distance and processes the control signal or the input signal. The signal reception unit 820 receives signals for moving a cursor vertically or horizontally or signals for choosing a menu and executing a function of the chosen menu. A message generation unit 830 generates a message for converting the control signal or the input signal received by the signal reception unit 820 into an event for a window. A message transmission unit 840 transmits the message generated by the message generation unit 830 to the application so that the application performs a function corresponding to the message.

The interface conversion unit 700 and the interface processing unit 800 may be incorporated into a desktop or laptop computer. Alternatively, only the interface processing unit 800 may be installed in a desktop computer or in a laptop computer. Data that provides a 10-foot user interface with the aid of the interface conversion unit 700 may also provide a 10-foot user interface with the aid of the interface processing unit 800. In other words, the interface processing unit 800 provides a 10-foot user interface without the aid of the interface conversion unit 700. Therefore, an application development company may create data that provides a 10-foot user interface with the aid of the interface conversion unit 700 and distribute the data to customers with the interface processing unit 800. In this case, the interface processing unit 800 provides a user with a 10-foot user interface even for an application that only provides a 2-foot user interface. The conversion of a 2-foot user interface into a 10-foot user interface may be carried out in a desktop computer or a laptop computer. An application development company may use only the interface conversion unit 700 for guaranteeing the efficiency of applications developed by the application development company.

According to an embodiment of the present invention, an existing application that provides a 2-foot user interface may be converted into an application that provides a 10-foot user interface without changing the driving mechanism of the existing application.

Therefore, existing applications that only provide a 2-foot user interface may be conveniently used from a longer distance. In addition, since data that defines a 10-foot user interface may be distributed via the Internet or using storage media such as diskettes, application development companies may reduce application development period and cost.

Moreover, existing applications in computer systems may be easily used together with various digital home appliances by simply adding a 10-foot user interface to the existing applications.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of converting a user interface of an application comprising:
displaying an application in a first mode, in which the user interface is controllable using a mouse or a keyboard;
collecting predetermined data that specifies an appearance of the application;
modifying the predetermined data to provide modified data enabling the application to be displayed in a second mode, in which the user interface is controllable with a remote control; and
storing the modified data.

2. The method of claim 1, wherein the modifying of the predetermined data comprises:
outputting the collected predetermined data;
outputting template data that enables the application to be displayed in the second mode; and
choosing a portion of the template data and receiving the chosen template data portion.

3. The method of claim 2, wherein, if the application is based on the Windows operating system, the predetermined data is resource information.

4. The method of claim 1, wherein, in the second mode, the application is displayed to be controllable from a distance of one meter or greater by a control signal received from the remote control.

5. The method of claim 1, wherein the predetermined data comprises information specifying functions provided by each of a plurality of elements of the application.

6. The method of claim 1, further comprising:
displaying the application in the second mode based on the stored modified data; and
receiving an input signal choosing one of a plurality of elements of the application from the remote control.

7. A method of displaying an application comprising:
receiving data that is needed for displaying the application in a browser window in a predetermined mode, in which the user interface is controllable with a remote control;
displaying the application in the predetermined mode; and
receiving an input signal choosing one of a plurality of elements of the application from the remote control.

8. The method of claim 7, wherein, in the predetermined mode, the application is displayed to be controllable from a distance of one meter or greater by a control signal received from the remote control.

9. The method of claim 7, wherein the predetermined data comprises information specifying functions provided by each of the elements of the application.

10. A computer system comprising:
an application analysis unit executing an application in a first mode, in which a user interface is controllable using a mouse or a keyboard and, if the application is executed in the first mode, collecting predetermined data specifying an appearance of the application; and
an application conversion unit which modifies the predetermined data to display the application in a second mode, in which the user interface is controllable with a remote control.

11. The computer system of claim 10, further comprising a template unit which outputs the predetermined data and template data to enable the second mode,
wherein the application conversion unit modifies the predetermined data based on a chosen portion of the template data.

12. The computer system of claim 10, wherein, in the second mode, the application is displayed to be controllable from a distance of one meter or greater by a control signal received from the remote control.

13. The computer system of claim 10, wherein the predetermined data comprises information for displaying a plurality of elements of the application and information for providing functions associated with each of the elements of the application.

14. The computer system of claim 10, wherein, if the application is based on the Windows operating system, the predetermined data is resource information.

15. A computer system comprising:
a signal reception unit receiving an input signal transmitted by a remote control;
a data reception unit receiving predetermined data for displaying an application in a browser window to execute the application in a predetermined mode, in which the user interface is controllable with a remote control; and
a display control unit displaying the application in the predetermined mode, wherein the display control unit performs a predetermined function of the application in response to the input signal while displaying the application in the predetermined mode.

16. The computer system of claim 15, wherein, in the predetermined mode, the application is displayed to be controllable from a distance of one meter or greater by a control signal received from the remote control.

17. The computer system of claim 15, wherein the predetermined data comprises information specifying functions provided by each of a plurality of elements of the application.

18. The computer system of claim 15, further comprising:
a message generation unit converting the input signal received by the signal reception unit into a message; and
a message transmission unit which transmits the message to the application.

19. A software program comprising:
an event processing unit converting an input signal transmitted by a remote control into an event signal for a predetermined element of an application; and
a control unit executing a function provided by the predetermined element when the element receives the event signal,
wherein the application is executed in a predetermined mode comprising the remotely controllable interface, and in the predetermined mode, the application is displayed to be controllable from a distance of one meter or greater using the remote control.

20. The software of claim 19, wherein the predetermined data comprises information specifying functions provided by each of a plurality of elements of the application.

21. A storage medium comprising:
predetermined data which specifies an application executable in a predetermined mode, in which a user interface is controllable with a remote control; and
an interface processing unit converting the application based on the predetermined data when the application is executed, wherein the predetermined data comprises information specifying functions provided by each of a plurality of elements of the application when a corresponding element is executed.

22. A method of converting a user interface of an application from a first user interface operable from a distance of less than one meter using a mouse or a keyboard to a second user interface operable from a distance of more than one meter using a remote control, the method comprising:
collecting data that specifies an appearance of the first user interface and corresponding functions of the application to be performed through the first user interface; and
constructing the second user interface through which the application is controllable with the remote control from the distance of more than one meter based on the collected data.

23. The method of claim 22, further comprising:
collecting the appearance and corresponding function data while displaying the first user interface using a mouse or a keyboard;

24. The method of claim 22, wherein the constructing of the second user interface comprises:
determining a display location of the second user interface.

25. The method of claim 24, wherein the display location of the second user interface is determined automatically.

26. The method of claim 24, wherein the display location is determined by a user.

27. The method of claim 22, further comprising:
storing the collected appearance and function data; and
constructing and displaying the second user interface based on the stored appearance and function data in response to executing the application.

28. The method of claim 22, further comprising:
collecting second data that specifies an appearance of a third user interface for a second application and corresponding functions of the second application to be performed through the third user interface; and
constructing a fourth user interface through which the second application is controllable with the remote control from the distance of more than one meter based on the collected second data.

29. The method of claim 22, wherein the collected data comprises:
resource information necessary to determine a shape and location of the second user interface.

30. The method of claim 22, further comprising:
linking the corresponding functions of the application to be performed through the first user interface to the second user interface.

31. The method of claim 22, wherein the constructing of the second user interface comprises;
displaying a preview window in which to construct the second user interface;
displaying a reference window including an interface list;
copying an image representing one of the corresponding functions of the application from the interface list to the preview window; and
linking the copied image to the one of the corresponding functions based on the collected data to perform the one of the corresponding functions by selecting the linked imaged using the remote control.

32. The method of claim 22, wherein the constructing of the second user interface comprises:
displaying a preview window comprising a plurality of images representing functions of the application;
removing selected ones of the plurality of images representing functions of the application which are not to be remotely controllable; and
linking remaining ones of the plurality of images in the preview window to corresponding functions of the application based on the collected data.

33. The method of claim 22, wherein the constructing of the second user interface comprises:
downloading the appearance and function data from a server;
storing the collected appearance and function data; and
constructing and displaying the second user interface based on the stored appearance and function data in response to executing the application.
